(19) United States
(12) Patent Application Publication
(10) Pub. No.: US 2017/0066911 A1
(43) Pub. Date: Mar. 9, 2017

(54) POLYMER COMPOSITIONS AND PROCESSING THEREOF

(71) Applicant: EIDGENÖSSISCHE TECHNISCHE HOCHSCHULE ZÜRICH, ZÜRICH (CH)

(72) Inventors: Theodorus TERVOORT, ZÜRICH (CH); Paul SMITH, ZÜRICH (CH); Raphael SCHALLER, ZÜRICH (CH); Kirrill FELDMAN, ZÜRICH (CH)

(73) Assignee: EIDGENÖSSISCHE TECHNISCHE HOCHSCHULE ZÜRICH, ZÜRICH (CH)

(21) Appl. No.: 15/123,254

(22) PCT Filed: Mar. 5, 2015
(86) PCT No.: PCT/EP2015/054577

§ 371 Date: Sep. 2, 2016

(30) Foreign Application Priority Data
Mar. 5, 2014 (EP) 14157941.7
Apr. 22, 2014 (EP) 14165490.5

(51) Int. Cl. C08L 23/08; D01F 6/04; C08L 23/06

(52) U.S. Cl. CPC C08L 23/0815; C08L 23/06; D01F 6/04; C08L 2203/12; C08L 2207/068

(57) ABSTRACT

Provided are compositions comprising a polymer and a solvent, which may be used for e.g. gel-processing. An example is a composition comprising a polyethylene polymer and a vegetable oil. The solvent may be a fairly poor solvent for the polymer.

### CROSS-REFERENCE TO RELATED APPLICATIONS

The present application claims priority to European patent application 14157941.7, filed 5 Mar. 2014, and to European patent application 14165490.5, filed 22 Apr. 2014. Both priority applications are hereby incorporated in their entirety by reference.

### FIELD

The present invention relates, inter alia, to polymer compositions, to processing the compositions, and to products made by processing the compositions.

### BACKGROUND

Processing of polymers has enjoyed considerable attention. For instance, gel-processing of ultra-high molecular weight polyethylene (UHMWPE) into high-strength fibers. See, e.g., U.S. Pat. No. 4,422,993, which is incorporated herein in its entirety by reference.

### SUMMARY

However, the processing still faces various issues, e.g. use of solvents that are hazardous, environmentally unfriendly, and/or expensive, use of low polymer concentration (and thus relatively high solvent quantities), etc.

In an embodiment, provided is a composition comprising a polymer and a solvent for the polymer, wherein the solvent comprises a vegetable oil.

In an embodiment, provided is a composition comprising a polymer and a solvent for the polymer, wherein the solvent is a relatively poor solvent for the polymer. In an embodiment, the composition comprises a high molecular weight polymer, in a relatively high polymer concentration, despite use of a relatively poor solvent.

In an embodiment, provided are processes using the present compositions.

In an embodiment, provided are articles made using the present compositions.

Additional objects, advantages and features of the present invention are set forth in this specification, and in part will become apparent to those skilled in the art on examination of the following, or may be learned by practice of the invention. The inventions disclosed in this application are not limited to any particular set of or combination of objects, advantages and features. It is contemplated that various combinations of the stated objects, advantages and features make up the inventions disclosed in this application.

### BRIEF DESCRIPTION OF THE DRAWINGS

FIG. 1 represents thermogravimetric analysis (TGA) curves of various solvents.

### DETAILED DESCRIPTION

In an embodiment, provided are compositions comprising a polymer and a solvent, wherein the solvent is a relatively poor solvent for the polymer. A parameter for determining the solubility quality of a solvent for a polymer is the crystallization temperature depression of the polymer that the solvent causes. This can be determined by comparing the peak crystallization temperature of the pure polymer with the peak crystallization temperature of the polymer in the solvent, as observed in differential scanning calorimetry (DSC) measurements [by heating from room temperature (25° C.) to above the crystalline melting temperature of the polymer (at a rate of 10° C./min), and then determining the peak crystallization temperature by subsequent cooling (also at a rate of 10° C./min)]. The larger the crystallization temperature depression, the higher the solubility quality of the solvent. In an embodiment, the solvent causes a crystallization temperature depression of the polymer of less than 10° C., e.g. less than 7° C. or less than 5° C. In an embodiment, the crystallization temperature depression is more than 1° C., e.g. more than 3° C.

If the crystallization temperature depression is high, the polymer may exhibit high chain swell. This, in turn, may result in high composition viscosity and associated processing difficulties and/or may force use of relatively low polymer concentrations. If the crystallization temperature depression is very low, the solvent may be too poor and not provide enough solubility or polymer disentanglement for adequate processing.

The desired crystallization temperature depression may be obtained by using a single solvent causing the desired crystallization temperature depression, but may also be obtained e.g. by combining a solvent of higher crystallization temperature depression with a solvent of lower crystallization temperature depression or even with a non-solvent.

If more than one polymer is present in the composition, the above crystallization depression numbers apply at least to the polymer that is present in the composition in the highest concentration.

In an embodiment, the solvent is selected from the group of solvents that, when compounded with polyethylene having a density of 0.93 g/cm³ and an elongational stress (F150/10), according to ISO 11542-2, of 0.51 MPa at a ratio of 80 wt % solvent and 20 wt % polyethylene, relative to the total amount of solvent and polyethylene, causes a reduction in crystallization temperature of the polyethylene in the range of 1-7° C.

In an embodiment, provided is a solvent comprising a conventional solvent (e.g., decalin) and at least one other component that has lower crystallization temperature depression (or even is a non-solvent). Although generally not preferred from e.g. a hazard point of view, it may e.g. be advantageous from a practical perspective to limit the changes made to a conventional process and still use relatively high concentrations of conventional solvent but lower the crystallization temperature depression. In an embodiment, the composition comprises at least 80 wt %, relative to the total weight of solvent, of conventional solvent. In an embodiment, the composition comprises less than 95 wt %, relative to the total weight of solvent, of conventional solvent.

In an embodiment, compositions are provided comprising a polymer and a solvent, wherein the solvent includes a vegetable oil. Vegetable oils are generally non-hazardous and/or renewable and/or edible and/or relatively cheap. Using one or more vegetable oils as (part of) the solvent may help in decreasing or eliminating hazardous, non-renewable, and/or costly components in the solvent. Examples are, e.g., olive oil, peanut oil, coconut oil, canola (rapeseed) oil, palm oil, or sunflower oil. In an embodiment, the solvent includes peanut oil. In an embodiment, at least 50 wt % of the solvent is comprised of a vegetable oil, e.g. at least 60 wt %, at least 80 wt %, at least 95 wt %, or 100 wt %.

In an embodiment, the composition includes an oil, e.g. a vegetable oil, comprising saturated fat, and/or mono-unsaturated fat, and/or poly-unsaturated fat. In an embodiment, the composition comprises an oil having, relative to the total amount of oil, between 5-30 wt % saturated components, between 20-80 wt % (e.g. between 50-80 wt %) mono-unsaturated components, and between 5-65 wt % (e.g. 5-35 wt %) poly-unsaturated components.

In an embodiment, the solvent has good thermal stability. In an embodiment, the solvent exhibits less than 5% weight loss in a thermogravimetric (TGA) measurement from 25° C. to 225° C. (heating rate 2° C./min; nitrogen atmosphere). Good thermal stability may allow processing (e.g. compounding of polymer and solvent) at higher temperatures, which may assist in faster and/or more homogeneous processing.

In an embodiment, the solvent is not a solid at 25° C. In an embodiment, the solvent is a liquid at 25° C. In an embodiment, the solvent is a paste at 25° C. Using a liquid or paste may help in preventing compositions being brittle, which—in some embodiments—can have processing advantages (e.g., may avoid higher processing temperatures and/or may facilitate shaping/stretching the compositions).

In an embodiment, the composition comprises a semicrystalline polymer. In an embodiment, the composition comprises a polymer selected from the group of polyethylene, polypropylene, polystyrene, polybutene-1, and poly(transisoprene). In an embodiment, the composition comprises a polyolefin. In an embodiment, the composition comprises a polyethylene. In an embodiment, the composition comprises a UHMW (ultra-high molecular weight) polyethylene.

In an embodiment, the polymer comprises co-monomer. In an embodiment, the composition comprises a polymer having up to 10 wt %, relative to the total weight of the polymer, of co-monomer, e.g. up to 5 wt %. In an embodiment, the polymer has at least 0.5 wt % co-monomer. In an embodiment, the co-monomer is an alpha-olefin co-monomer, e.g. an alpha olefin co-monomer having up to 20 carbon atoms, e.g. up to 10 carbon atoms or up to 5 carbon atoms. In an embodiment, the co-monomer is selected from the group of propylene, 1-butene, 1-pentene, 4-methyl-pentene, 1-hexene, and 1-octene.

In an embodiment, the composition comprises a polymer having a weight average molecular weight of at least 500 kg/mol, e.g. at least 1000 kg/mol, at least 2000 kg/mol, or at least 4000 kg/mol. In an embodiment, the polymer has a weight average molecular weight of less than 15000 kg/mol, e.g. less than 12000 kg/mol, less than 9000 kg/mol or less than 7000 kg/mol. In an embodiment, the weight average molecular weight is in the range of 3000-8000 kg/mol. In an embodiment, the weight average molecular weight is in the range of 3000-5000 kg/mol.

In an embodiment, the composition comprises a polyolefin having an elongational stress F(150/10) of at least 0.15 MPa, e.g. at least 0.2 MPa. In an embodiment, the elongational stress F(150/10) is less than 0.6 MPa.

In an embodiment, the composition comprises, relative to the total weight of polymer and solvent, 5 or more wt % of polymer, e.g. at least 10 wt % of polymer, at least 15 wt % or at least 20 wt %. In an embodiment, the composition comprises, relative to the total weight of polymer and solvent, less than 75 wt % of polymer, e.g. less than 60 wt %, less than 50 wt %, less than 40 wt %, or less than 35 wt %. In an embodiment, the composition comprises 15-25 wt % polymer.

In an embodiment, the composition comprises one or more additives, e.g. antioxidants, nucleating agents, clarifying agents, colorants, blowing agents, foaming agents, or fillers. In an embodiment, the composition comprises antioxidants.

In an embodiment, at least 50 wt %, relative to the total weight of the composition, consists of polymer and solvent, e.g. at least 70 wt %, at least 85 wt %, at least 95 wt %, or at least 98 wt %.

In an embodiment, the compositions consist, or consist essentially, of the polymer, the solvent, and—optionally—additives.

In an embodiment, the composition has a melt flow rate “MFR” (ISO1133, 10 kg, 180° C.) of at least 10 g/min, e.g. at least 15 g/min or at least 20 g/min. In an embodiment, the composition has a melt flow rate of less than 50 g/min.

In an embodiment, the compositions are processed into a product, e.g. by extruding the compositions, or by injection molding, blow molding, calendaring, compression molding, transfer molding, spinning, and the like. In an embodiment, the solvent and polymer, and optionally other components, are mixed during said processing to form the composition. In an embodiment, the composition is already formed prior to said processing. In an embodiment, the process is a gel-processing process.

In an embodiment, the compositions are processed into products such as fibers, films, foams, or membranes. In an embodiment, the products, e.g. fibers or films, are subsequently drawn to enhance the mechanical properties. In an embodiment, the products are drawn in one direction. In an embodiment, the products are drawn in more than one, e.g. in two, directions.

In an embodiment, the solvent is at least partly removed from the product, e.g. by extraction. For instance, by washing the product in isopropanol. In an embodiment, the solvent is at least partly removed during the above-mentioned drawing. In an embodiment, the solvent is at least partly removed prior to the above-mentioned drawing. In an embodiment, the solvent is at least partly removed past the above-mentioned drawing.

In an embodiment, not all of the solvent is removed from the product. E.g., in embodiments where removing all solvent is not cost-effective and/or in embodiments where it is advantageous to leave some solvent in (e.g., for lubrication purposes). In an embodiment, the product comprises more than 0.05 wt %, relative to the total weight of polymer and solvent, solvent. For instance more than 0.1 wt % or more than 0.25 wt %. In an embodiment, the product comprises less than 15 wt %, relative to the total weight of polymer and solvent, solvent. For instance less than 10 wt %, less than 5 wt %, less than 1.5 wt %, less than 0.75 wt %, less than 0.4 wt %, or less than 0.2 wt %.

In an embodiment, the product, e.g. fiber or film, has after drawing a modulus of at least 40 GPa, e.g. at least 60 GPa, at least 90 GPa, at least 120 GPa, or at least 145 GPa. In an embodiment, the modulus is less than 250 GPa, e.g. less than 200 GPa.

In an embodiment, the product, e.g. fiber or film, has a strength after drawing of at least 2.1 GPa, e.g. at least 2.5 GPa or at least 2.8 GPa. In an embodiment, the strength is less than 4.0 GPa, e.g. less than 3.5 GPa.

In an embodiment, provided are articles comprising, or consisting of, the products, e.g., an anti-ballistic article (bulletproof vests, bulletproof helmets, bulletproof panels, etc.), a fishing line, a fishing net, a sports article (e.g. a tennis racket), a rope, a balloon, a surgical suture, a dental floss, a porous membrane, a battery separator, or a sail.

Also provided is granulate comprising a composition according to the present invention. This may be obtained, e.g., by extruding a composition according to the present invention into a strain and then chopping the strain into granulate.

### Further Embodiments

1. A composition comprising a polymer and a solvent for the polymer, wherein
the polymer has an elongational stress F(150/10) of at least 0.15 MPa,
the polymer is a polyolefin, and
the composition has a crystallization temperature that is less than 10° C. lower, e.g. less than 7° C. lower, than the crystallization temperature of the polymer.
   2. A composition comprising a polymer and a solvent for the polymer, wherein
the polymer has an elongational stress F(150/10) of at least 0.15 MPa,
the polymer is a polyolefin, and
the solvent comprises a vegetable oil.
   3. A composition comprising a polymer and a solvent for the polymer, wherein
the polymer has an elongational stress F(150/10) of at least 0.15 MPa,
the polymer is a polyolefin,
the composition has a crystallization temperature that is less than 10° C. lower than the crystallization temperature of the polymer, and
the solvent is a liquid or paste at 25° C.
   4. A composition comprising a polymer and a solvent for the polymer, wherein
the polymer has an elongational stress F(150/10) of at least 0.15 MPa,
the polymer is a polyolefin,
the composition has a crystallization temperature that is less than 10° C. lower than the crystallization temperature of the polymer, and
the solvent is selected from the group of solvents that shows less than 5 wt % weight decrease in a TGA measurement from 25° C. to 250° C.
   5. The composition according to any one of embodiments 1-4, wherein the polymer has an elongational stress F(150/10) of at least 0.2 MPa.
   6. The composition according to any one of embodiments 1-5, wherein the polymer has an elongational stress F(150/10) of less than 0.6 MPa.
   7. A composition comprising a polymer and a solvent for the polymer, wherein
the polymer has a weight average molecular weight of at least 500 kg/mol, and
the composition has a crystallization temperature that is less than 10° C. lower, e.g. less than 7° C. lower, than the crystallization temperature of the polymer.
   8. A composition comprising a polymer and a solvent for the polymer, wherein
the polymer has a weight average molecular weight of at least 500 kg/mol, and
the solvent comprises a vegetable oil.
   9. A composition comprising a polymer and a solvent for the polymer, wherein
the polymer has a weight average molecular weight of at least 500 kg/mol,
the composition has a crystallization temperature that is less than 10° C. lower than the crystallization temperature of the polymer, and
the solvent is a liquid or paste at 25° C.
   10. A composition comprising a polymer and a solvent for the polymer, wherein
the polymer has a weight average molecular weight of at least 500 kg/mol,
the composition has a crystallization temperature that is less than 10 C lower than the crystallization temperature of the polymer, and
the solvent is selected from the group of solvents that shows less than 5 wt % weight decrease in a TGA measurement from 25° C. to 250° C.
   11. A composition according to any one of embodiments 7-10, wherein the polymer has a weight average molecular weight of at least 2000 kg/mol.
   12. A composition according to any one of embodiments 7-11, wherein the polymer has a weight average molecular weight of less than 15000 kg/mol.
   13. A composition according to any one of embodiments 7-11, wherein the polymer has a weight average molecular weight of less than 10000 kg/mol.
   14. The composition according to any one of embodiments 7-13, wherein the polymer is a polyolefin.
   15. The composition according to any one of embodiments 1-13, wherein the polymer is polyethylene.
   16. The composition according to any one of embodiments 1-15, wherein the polymer comprises up to 10 wt %, relative to the total weight of the polymer, of co-monomer.
   17. The composition according to any one of embodiments 1-15, wherein the polymer comprises up to 5 wt %, relative to the total weight of the polymer, of co-monomer.
   18. The composition according to any one of embodiments 1-17, wherein the polymer comprises an alpha-olefin co-monomer having up to 20 carbon atoms.
   19. The composition according to any one of embodiments 1-17, wherein the polymer comprises an alpha-olefin co-monomer having up to 10 carbon atoms.
   20. The composition according to any one of embodiments 1-17, wherein the polymer comprises an alpha-olefin co-monomer having up to 5 carbon atoms.
   21. The composition according to any one of embodiments 1-20, wherein the composition comprises, relative to the total weight of polymer and solvent, at least 10 wt % polymer.
   22. The composition according to any one of embodiments 1-21, wherein the composition comprises, relative to the total weight of polymer and solvent, at most 60 wt % polymer.
   23. The composition according to any one of embodiments 1-20, wherein the composition comprises, relative to the total weight of polymer and solvent, 15-35 wt % polymer.
   24. The composition according to any one of embodiments 1-23, wherein the solvent comprises at least 50 wt %, relative to the total weight of solvent, of a vegetable oil.
   25. The composition according to any one of embodiments 1-23, wherein the solvent consists of one or more vegetable oils.
   26. The composition according to any one of embodiments 1-25, wherein the composition consists essentially of said polymer and solvent.
   27. The composition according to any one of embodiments 1-25, wherein the composition consists of said polymer, said solvent, and one or more additives.
   28. The composition according to any one of embodiments 1-27, wherein the solvent comprises a saturated vegetable oil.
   29. The composition according to any one of embodiments 1-28, wherein the solvent comprises a mono-unsaturated vegetable oil.
   30. The composition according to any one of embodiments 1-29, wherein the solvent comprises a poly-unsaturated vegetable oil.
   31. The composition according to any one of embodiments 1-30, wherein the solvent has a density that is less than 10% different from the density of the polymer.
   32. The composition according to any one of embodiments 1-31, wherein the composition has a crystallization temperature that is less than 5° C. lower than the crystallization temperature of the polymer.
   33. The composition according to any one of embodiments 1-31, wherein the composition has a crystallization temperature that is between 3-5° C. lower than the crystallization temperature of the polymer.
   34. The composition according to any one of embodiments 1-33, wherein the composition has an MFR of more than 10 g/10 min.
   35. The composition according to any one of embodiments 1-33, wherein the composition has an MFR in the range of 10-35 g/10 min.
   36. A composition comprising polyethylene and a solvent for the polyethylene, wherein:
the polyethylene has a weight average molecular weight in the range of 2000-15000 kg/mol;
the solvent comprises a vegetable oil; and
the composition comprises, relative to the total weight of the polyethylene and the solvent, 10-30 wt % polyethylene.
   37. The composition of embodiment 36, wherein the polyethylene comprises up to 5 wt %, relative to the total weight of polyethylene, of co-monomer.
   38. The composition according to any one of embodiments 36-37, wherein the composition consists of said polyethylene, said solvent, and one or more additives.
   39. The composition according to any one of embodiments 1-38, wherein the solvent comprises peanut oil.
   40. The composition according to any one of embodiments 1-39, wherein the solvent is a paste at 25° C.
   41. A composition comprising a plurality of polymers and a solvent for the plurality of polymers, the plurality of polymers including a polymer having a molecular weight of at least 500 kg/mol, and the composition having a crystallization temperature that is less than 10° C. lower than the crystallization temperature of the polymer having a molecular weight of at least 500 kg/mol.
   42. The composition of embodiment 41, wherein the solvent includes a vegetable oil.
   43. The composition according to any one of embodiments 41-42, wherein the solvent shows less than 5% weight reduction (as determined by a TGA measurement from 25° C. to 225° C., at a heating rate of 2° C./min, under nitrogen atmosphere).
   44. A composition comprising a polymer and a solvent, wherein
the polymer is a polyolefin,
the polymer has an elongational stress (F150/10) of at least 0.15 MPa,
the polymer is present in an amount of at least 10 wt %, relative to the total amount of polymer and solvent, and
the solvent is selected from the group of solvents that, when compounded with polyethylene having a density of 0.93 g/cm³ and an elongational stress (F150/10) of 0.51 MPa at a ratio of 80 wt % solvent and 20 wt % polyethylene, relative to the total amount of solvent and polyethylene, causes a reduction in crystallization temperature of the polyethylene in the range of 1-7° C.
   45. A composition comprising a polymer and a solvent, wherein
the polymer has a weight average molecular weight of at least 1000 kg/mol,
the polymer is present in an amount of at least 10 wt %, relative to the total amount of polymer and solvent, and
the solvent is selected from the group of solvents that, when compounded with polyethylene having a density of 0.93 g/cm³ and an elongational stress F(150/10) of 0.51 MPa at a ratio of 80 wt % solvent and 20 wt % polyethylene, relative to the total amount of solvent and polyethylene, causes a reduction in crystallization temperature of the polyethylene in the range of 1-7° C.
   46. A composition comprising a polymer and a solvent for the polymer, wherein
the polymer has an elongational stress F(150/10) of at least 0.15 MPa,
the polymer is a polyolefin, and
the solvent comprises decalin and at least one other component.
   47. The composition of embodiment 46, wherein the solvent comprises, relative to the total weight of the solvent, at least 80 wt % decalin.
   48. The composition according to any one of embodiments 46-47, wherein the solvent comprises, relative to the total weight of the solvent, less than 95 wt % decalin.
   49. The composition according to any one of embodiments 46-48, wherein the at least one other component includes a non-solvent for the polymer.
   50. The composition according to any one of embodiments 46-48, wherein the at least one other component includes a vegetable oil.
   51. The composition according to any one of embodiments 46-48, wherein the at least one other component includes mineral oil or paraffin oil.
   52. The composition according to any one of embodiments 46-49, wherein the composition has a crystallization temperature that is less than 20° C. lower, e.g. less than 10° C. lower, than the crystallization temperature of the polymer.
   53. A composition comprising a polymer and a solvent for the polymer, wherein
the polymer has a weight average molecular weight of at least 500 kg/mol, and
the solvent comprises decalin and at least one other component.
   54. The composition of embodiment 53, wherein the solvent comprises, relative to the total weight of the solvent, at least 80 wt % decalin.
   55. The composition according to any one of embodiments 53-54, wherein the solvent comprises, relative to the total weight of the solvent, less than 95 wt % decalin.
   56. The composition according to any one of embodiments 53-55, wherein the at least one other component includes a non-solvent for the polymer.
   57. The composition according to any one of embodiments 53-56, wherein the at least one other component includes a vegetable oil.
   58. The composition according to any one of embodiments 53-56, wherein the at least one other component includes mineral oil or paraffin oil.
   59. The composition according to any one of embodiments 53-57, wherein the composition has a crystallization temperature that is less than 20° C. lower, e.g. less than 10° C. lower, than the crystallization temperature of the polymer.
   60. The composition according to any one of embodiments 46-59, wherein the polymer is polyethylene.
   61. The composition according to any one of embodiments 46-60, wherein the polymer comprises up to 10 wt %, relative to the total weight of the polymer, of co-monomer.
   62. The composition according to any one of embodiments 46-60, wherein the polymer comprises up to 5 wt %, relative to the total weight of the polymer, of co-monomer.
   63. The composition according to any one of embodiments 46-62, wherein the polymer comprises an alpha-olefin co-monomer having up to 20 carbon atoms.
   64. The composition according to any one of embodiments 46-62, wherein the polymer comprises an alpha-olefin co-monomer having up to 10 carbon atoms.
   65. The composition according to any one of embodiments 46-62, wherein the polymer comprises an alpha-olefin co-monomer having up to 5 carbon atoms.
   66. The composition according to any one of embodiments 46-65, wherein the composition comprises, relative to the total weight of polymer and solvent, at least 10 wt % polymer.
   67. The composition according to any one of embodiments 46-66, wherein the composition comprises, relative to the total weight of polymer and solvent, at most 60 wt % polymer.
   68. The composition according to any one of embodiments 46-65, wherein the composition comprises, relative to the total weight of polymer and solvent, 15-35 wt % polymer.
   69. The composition according to any one of embodiments 46-68, wherein the composition consists essentially of said polymer and solvent.
   70. The composition according to any one of embodiments 46-68, wherein the composition consists of said polymer, said solvent, and one or more additives.
   71. A process comprising processing the composition according to any one of embodiments 1-70 to form a shaped product.
   72. The process of embodiment 71, wherein said processing includes extruding, calendaring, blow molding, and/or injection molding.
   73. The process according to any one of embodiments 71-72, wherein the components are combined, and the composition is thereby formed, during said processing.
   74. The process according to any one of embodiments 71-72, wherein the composition was already formed prior said processing.
   75. The process according to any one of embodiments 71-74, further comprising drawing the product in one or more directions.
   76. The process according to embodiment 75, wherein the drawing is in one direction.
   77. The process according to any one of embodiments 75-76, wherein the process comprises drawing the product to a draw ratio of at least 10.
   78. The process according to any one of embodiments 75-76, wherein the process comprises drawing the product to a draw ratio in the range of 10-100.
   79. The process according to any one of embodiments 75-76, wherein the process comprises drawing the product to a draw ratio in the range of 15-40.
   80. The process according to any one of embodiments 71-79, wherein the process further comprises removing the solvent from the product.
   81. The process according to any one of embodiments 75-80, comprising removing at least part of the solvent prior to said drawing.
   82. The process according to any one of embodiments 75-81, comprising removing at least part of the solvent during or after said drawing.
   83. The process according to any one of embodiments 71-82, wherein the product is a fiber.
   84. The process according to any one of embodiments 71-83, wherein the product is a film.
   85. A foam, foil, tape, sheet, plaque, tube, container, felt, or membrane obtained with the process according to any one of embodiments 71-74.
   86. A fiber obtained with the process according to any one of embodiments 71-83.
   87. The fiber of embodiment 86, the fiber having a tensile modulus of at least 100 GPa.
   88. The fiber of embodiment 87, the fiber having a tensile modulus of 130-180 GPa.
   89. A polyolefin product comprising vegetable oil, the oil being present in an amount of less than 5 wt %, relative to the total amount of polyolefin and oil.
   90. The polyolefin product of embodiment 89, wherein the polyolefin is polyethylene.
   91. The polyolefin product according to any one of embodiments 89-90, wherein the amount of vegetable oil is less than 1 wt %.
   92. The polyolefin product according to any one of embodiments 89-90, wherein the amount amount of vegetable oil is less than 0.2 wt %.
   93. The polyolefin product according to any one of embodiments 89-92, wherein the amount amount of vegetable oil is at least 0.05 wt %.
   94. The polyolefin product according to any one of embodiments 89-93, wherein the polyolefin product is a foam, foil, tape, fiber, or membrane.
   95. The polyolefin product of embodiment 94, wherein the polyolefin product is a fiber.
   96. The fiber of embodiment 95, the fiber having a modulus greater than 100 GPa.
   97. An article comprising the product according to any one of embodiments 85-96, the article being an anti-ballistic article, a rope, a fishing article, a panel, a balloon, a sports article, a surgical suture, a dental floss, a porous membrane, a battery separator, or a sail.
   98. Granulate comprising the composition according to any one of embodiments 1-45.
   99. A composition comprising a polyolefin, the polyolefin comprising co-monomer, and a solvent for the polyolefin, wherein
the polymer has an elongational stress F(150/10) of at least 0.15 MPa,
the composition has a crystallization temperature that is less than 10° C. lower than the crystallization temperature of the polyolefin.
   100. A composition comprising a polyolefin, the polyolefin comprising co-monomer, and a solvent for the polyolefin, wherein
the polymer has a weight average molecular weight of at least 500 kg/mol,
the composition has a crystallization temperature that is less than 10° C. lower than the crystallization temperature of the polyolefin.
   101. A process comprising gel-processing a polyethylene having a weight average molecular weight of at least 500 kg/mol, wherein the polyethylene comprises co-monomer.

### EXAMPLES

The following examples are given as particular embodiments of the invention and to demonstrate the practice and advantages thereof. It is understood that the examples are given by way of illustration and are not intended to limit the specification or the claims that follow in any manner.

Polymers

“PE-1” referred to in the examples is an ultra-high molecular weight polyethylene with a density of 0.93 g/cm³, measured according to ISO 1183 test method A, and an elongational stress F(150/10) of 0.51 MPa, measured according to ISO 11542-2. It is commercially sold by Ticona under the name GUR4150.

“PE-2” referred to in the examples is an ultra-high molecular weight polyethylene, comprising co-monomer, with a density of 0.925 g/cm³, measured according to ISO 1183 test method A, and an elongational stress F(150/10) of 0.2 MPa, measured according to ISO 11542-2. It is commercially sold under the name UTEC3041 by Braskem.

Compounding

Polymer powder, antioxidant, and solvent were added to a round-bottom flask. The antioxidants used were Irganox 1010 and Irgafos 1068, both from Ciba AG, Switzerland, each in an amount of 0.5 wt % relative to the total weight of polymer. The amounts of polymer and solvent, except where expressly indicated otherwise, are expressed in weight % relative to the total amount of polymer+solvent. The flask was heated to 90° C. to ensure dissolution of the antioxidant in the solvent; the resulting slurry was kept under continuous mixing with a magnetic stirrer. About 8 ml of slurry was collected with a syringe and fed into a laboratory co-rotating twin-screw micro-compounder, operating under nitrogen purge and at 150 rpm. The residence time was kept at least 10 minutes. The processing temperature was in the range of 180-230° C. The extruded strands were cooled to room temperature and collected.

Tensile-Drawing

After compounding, the collected strands were washed in various solvents, including isopropanol (at 50° C.), heptane, dichloromethane and diethyl ether (at room temperature) for 30 min. Tensile drawing of the samples was performed by stretching on a hot shoe at temperatures between 125° C.-150° C. The nominal draw ratio was measured from the displacement of ink marks that were printed on the original sample at 1 cm intervals.

Mechanical Testing

Tensile measurements were conducted with an Instron 5864 static mechanical tester, fitted with 100 N load cell and equipped with pneumatic clamps. The crosshead speed was set to 20 mm/min. All tests on the drawn samples were performed at room temperature (22-24° C.). The samples had a gauge length of 70 mm; the cross-sectional area was calculated from sample length and sample weight, assuming a density of 1 g/cm³. Unless indicated otherwise, all reported values for the modulus, tensile strength, and elongation at break refer to an average of at least three measurements.

Rheology

The melt flow rate (MFR) of PE-1 compositions (polymer to solvent ratio was 20:80 (wt:wt) was measured with a melt-flow indexer (MeltFlow LT, Haake, Germany) according to ISO1133, using a weight of 10 kg at a temperature of 180° C. All reported values refer to an average of 7 measurements, at 10 minutes collection time.

Thermal Analysis

Differential scanning calorimetry was performed using a DSC 822e from Mettler Toledo, Switzerland, and calibrated with Indium. DSC thermograms were recorded under nitrogen at heating and cooling rates of 10° C./min. Samples were heated from 25° C. to 180° C. and then cooled to 25° C. (“first cooling curve”). The sample weight was about 10 mg. Reported crystallization temperature values are the peak crystallization temperatures in the first cooling scans.

Thermogravimetric analysis (TGA) was conducted with a TGA/SDTA 851e (Mettler-Toledo AG, Swizerland) instrument. Alumina crucibles with about 15 mg of material were heated from 150° C. to 230° C. at a rate of 2° C./min under nitrogen purge at a rate of 50 ml/min.

### Example 1

Crystallization temperature depression of PE-1 in various solvents was measured. Also the crystallization temperature of the pure PE1 was determined. See Table 1.

TABLE 1
Crystallization temperature depression of PE-1 in various solvents

| | Weight % | | |
|---|---|---|---|
| | PE-1* | Tcryst (° C.) | ΔTcryst (° C.) |
| PE-1 | 100 | 117.6 | 0.0 |
| Decalin | 20 | 78.7 | 38.9 |
| Mineral Oil | 20 | 107.2 | 10.4 |
| Paraffin Oil | 20 | 106.6 | 11.0 |
| Canola Oil | 20 | 115.6 | 2.0 |
| Sunflower Oil | 20 | 115.5 | 2.1 |
| Peanut Oil | 20 | 114.6 | 3.0 |
| Olive Oil | 20 | 114.8 | 2.8 |
| Stearic Acid:Peanut Oil | 20 | 112.7 | 4.9 |
| 1:1 (wt:wt) | | | |

*Weight % is relative to total amount of solvent and PE-1.

### Example 2

The melt flow rates of various PE-1/solvent compositions were determined. See Table 2.

TABLE 2
Melt-flow rates (MFR).
PE-1 Compositions

| | |
|---|---|
| Solvent | MFR (grams per 10 minutes) |

| | |
|---|---|
| Decalin | 0.1 |
| Mineral Oil | 2.6 |
| Peanut Oil | 12.3 |
| Olive Oil | 13.5 |
| Stearic Acid/Peanut Oil (1:1) | 28.5 |

### Example 3

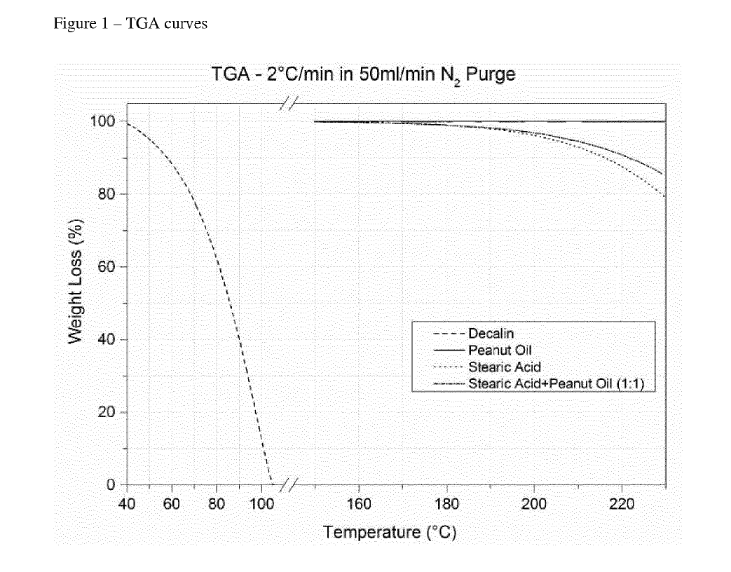

Thermogravimetric analysis of decalin, peanut oil, stearic acid and a 1:1 wt/wt mixture of peanut oil and stearic acid was performed. The results are shown in FIG. 1.

### Example 4

In the below table are listed the mechanical properties of fibers of PE-1 and PE-2 that were produced by processing the polymers from vegetable oils at a polymer to solvent ratio of 20:80 (wt:wt), extracted, dried and drawn, over a hot shoe at a temperature of 120° C., to their maximum ratio.

| | E-Modulus | Strength | Elongation |
|---|---|---|---|
| Sample | (GPa) | (GPa) | at Break (%) |
| PE-1, 20 wt % in Decalin | 28 | 2.0 | 8.4 |
| PE-1, 20 wt % in Peanut Oil | 69 | 2.2 | 5.3 |
| PE-1, 20 wt % in Olive Oil | 57 | 2.2 | 4.3 |
| PE-2, 20 wt % in Peanut | 167 | 3.0 | 2.7 |
| Oil:Stearic Acid (1:1 wt/wt) | | | |

### Example 5

In the below table are listed the mechanical properties of fibers of PE-1 and PE-2 that were produced by processing the polymers from solutions in peanut oil at different polymer concentrations, extracted, dried and drawn over a hot shoe at a temperatures between 125-150° C., to their maximum draw ratio.

| | Concentration | Max. Draw | E-Modulus | Strength |
|---|---|---|---|---|
| Material | % w/w | Ratio | GPa | GPa |
| PE-1 | 10 | 28 | 117 | 3.1 |
| | 30 | 17 | 42 | 2.1 |
| | 40 | 13 | 30 | 1.8 |
| PE-2 | 10 | 30 | 159 | 3.0 |

### Example 6

In the below table are listed the mechanical properties of fibers of PE-2 that were produced by processing the polymer from solutions in peanut oil/stearic acid (1:1 w/w) at different concentrations, extracted, dried and drawn over a hot shoe at a temperatures between 125-150° C., to their maximum draw ratio.

| | | E-Modulus, | | Strength, | | |
|---|---|---|---|---|---|---|
| Solution | | GPa | | GPa | | |
| Concentration, | Draw | | Best | | Best | Elong. at |
| % w/w | Ratio | Average | Value | Average | Value | Break, % |
| 30 | 26-28 | 91 | 95 | 2.0 | 2.2 | 3.3 |
| 40 | 26-28 | 111 | 126 | 2.6 | 2.7 | 3.5 |

### Example 7

In the below table are listed the mechanical properties of fibers of PE-1 and PE-2 that were produced by processing the polymers from solutions at different concentrations, extracted, dried and drawn over a hot shoe at a temperatures between 125-150° C., to their maximum draw ratio.

| | E-Modulus, | Strength, | Elong. at |
|---|---|---|---|
| Sample | GPa | GPa | Break, % |
| PE-1, 20 wt % in Olive Oil* | 57 | 2.17 | 4.3 |
| PE-2, 20 wt % in | 167 | 2.95 | 2.7 |
| Peanut Oil:Stearic Acid | | | |
| (1:1 w/w) | | | |
| PE-2, 15 wt % in Peanut Oil* | 120 | 2.15 | 2.7 |

*Single measurement

### Example 8

In the below table are listed the mechanical properties of fibers of PE-1 and PE-2 that were produced by processing the polymers from solutions at different concentrations in decalin, extracted, dried and drawn over a hot shoe at a temperatures between 125-150° C., to their maximum draw ratio.

| | Draw | | | |
|---|---|---|---|---|
| | Ratio | E-Modulus | Strength | Elongation at |
| Sample | (—) | (GPa) | (GPa) | Break (%) |
| PE-1, 30 wt % in Decalin | 18 | 20 | 1 | 13.0 |
| PE-2, 10 wt % in Decalin | 30 | 90 | 1.8 | 3.6 |

### Example 9

In the below table are listed the mechanical properties of fibers of PE-1 that were produced by processing the polymers from a Decalin/Dodecanol solution, extracted, dried and drawn over a hot shoe at a temperatures between 125-150° C., to their maximum draw ratio.

| | Draw | | | |
|---|---|---|---|---|
| | Ratio | E-Modulus | Strength | Elongation at |
| Sample | (—) | (GPa) | (GPa) | Break (%) |
| PE-1, 10 wt % in Decalin- | 50 | 140 | 2.1 | 2.5 |
| Dodecanol (1:1 wt/wt) | | | | |
| PE-1, 20 wt % in Decalin- | 30 | 105 | 2.4 | 3.3 |
| Dodecanol (1:1 wt/wt) | | | | |
| PE-1, 30 wt % in Decalin- | 20 | 40 | 1.1 | 3.6 |
| Dodecanol (1:1 wt/wt) | | | | |
| PE-1, 20 wt % in Decalin- | 25 | 70 | 1.5 | 3.2 |
| Dodecanol (4:1 wt/wt) | | | | |

Having described specific embodiments of the present invention, it will be understood that many modifications thereof will readily appear or may be suggested to those skilled in the art, and it is intended therefore that this invention is limited only by the spirit and scope of the following claims.

What is claimed is:

1. A composition comprising a polymer and a solvent for the polymer, wherein
the polymer has an elongational stress F(150/10) of at least 0.15 MPa,
the polymer is a polyolefin, and
the composition has a crystallization temperature that is less than 10° C. lower than the crystallization temperature of the polymer.

2. The composition of claim 1, wherein the solvent comprises a vegetable oil.

3. The composition according to any one of claims 1-2, wherein the solvent is a liquid or paste at 25° C.

4. The composition according to any one of claims 1-3, wherein the solvent is selected from the group of solvents that shows less than 5 wt % weight decrease in a TGA measurement from 25° C. to 250° C.

5. The composition according to any one of claims 1-4, wherein the polymer has an elongational stress F(150/10) of at least 0.2 MPa.

6. The composition according to any one of claims 1-5, wherein the polymer has an elongational stress F(150/10) of less than 0.6 MPa.

7. The composition according to any one of claims 1-6, wherein the polymer has a weight average molecular weight of at least 2000 kg/mol.

8. The composition according to any one of claims 1-7, wherein the polymer has a weight average molecular weight of less than 15000 kg/mol.

9. The composition according to any one of claims 1-8, wherein the polymer has a weight average molecular weight of less than 10000 kg/mol.

10. The composition according to any one of claims 1-9, wherein the polymer is a polyolefin.

11. The composition according to any one of claims 1-10, wherein the polymer is polyethylene.

12. The composition according to any one of claims 1-11, wherein the polymer comprises up to 10 wt %, relative to the total weight of the polymer, of co-monomer.

13. The composition according to any one of claims 1-12, wherein the polymer comprises up to 5 wt %, relative to the total weight of the polymer, of co-monomer.

14. The composition according to any one of claims 1-13, wherein the polymer comprises an alpha-olefin co-monomer having up to 20 carbon atoms.

15. The composition according to any one of claims 1-14, wherein the polymer comprises an alpha-olefin co-monomer having up to 10 carbon atoms.

16. The composition according to any one of claims 1-15, wherein the polymer comprises an alpha-olefin co-monomer having up to 5 carbon atoms.

17. The composition according to any one of claims 1-16, wherein the composition comprises, relative to the total weight of polymer and solvent, at least 10 wt % polymer.

18. The composition according to any one of claims 1-17, wherein the composition comprises, relative to the total weight of polymer and solvent, 15-35 wt % polymer.

19. The composition according to any one of claims 1-18, wherein the solvent comprises at least 50 wt %, relative to the total weight of solvent, of a vegetable oil.

20. The composition according to any one of claims 1-19, wherein the solvent consists of one or more vegetable oils.

21. The composition according to any one of claims 1-20, wherein the composition consists of said polymer, said solvent, and one or more additives.

22. The composition according to any one of claims 1-21, wherein the solvent comprises a saturated vegetable oil.

23. The composition according to any one of claims 1-22, wherein the solvent comprises a mono-unsaturated vegetable oil.

24. The composition according to any one of claims 1-22, wherein the solvent comprises a poly-unsaturated vegetable oil.

25. The composition according to any one of claims 1-24, wherein the solvent has a density that is less than 10% different from the density of the polymer.

26. The composition according to any one of claims 1-25, wherein the composition has a crystallization temperature that is less than 5° C. lower than the crystallization temperature of the polymer.

27. The composition according to any one of claims 1-26, wherein the composition has a crystallization temperature that is between 3-5° C. lower than the crystallization temperature of the polymer.

28. The composition according to any one of claims 1-27, wherein the composition has an MFR of more than 10 g/10 min.

29. A composition comprising a polymer and a solvent for the polymer, wherein
the polymer has an elongational stress F(150/10) of at least 0.15 MPa,
the polymer is a polyolefin, and
the solvent comprises decalin and at least one other component.

30. The composition according to claim 29, wherein the at least one other component includes a non-solvent for the polymer.

31. The composition according to any one of claims 29-30, wherein the composition has a crystallization temperature that is less than 20° C. lower than the crystallization temperature of the polymer.

32. The composition according to any one of claims 29-31, wherein the polymer comprises up to 10 wt %, relative to the total weight of the polymer, of co-monomer.

33. The composition according to any one of claims 29-32, wherein the composition comprises, relative to the total weight of polymer and solvent, at least 10 wt % polymer.

34. A process comprising processing the composition according to any one of claims 1-33 to form a shaped product.

35. The process of claim 34, wherein said processing includes extruding, calendaring, blow molding, and/or injection molding.

36. The process according to any one of claims 34-35, wherein the components are combined, and the composition is thereby formed, during said processing.

37. The process according to any one of claims 34-35, wherein the composition was already formed prior said processing.

38. The process according to any one of claims 34-37, further comprising drawing the product in one or more directions.

39. The process according to any one of claims 34-38, wherein the process comprises drawing the product to a draw ratio of at least 10.

40. The process according to any one of claims 34-38, wherein the process comprises drawing the product to a draw ratio in the range of 15-40.

41. The process according to any one of claims 34-40, comprising removing at least part of the solvent prior to said drawing.

42. The process according to any one of claims 34-41, comprising removing at least part of the solvent during or after said drawing.

43. The process according to any one of claims 34-42, wherein the product is a fiber.

44. A fiber obtained with the process according to any one of claims 34-42.

45. The fiber of claim 44, the fiber having a tensile modulus of at least 100 GPa.

46. Granulate comprising the composition according to any one of claims 1-33.
